(19) United States
(12) Patent Application Publication
(10) Pub. No.: US 2009/0299819 A1
(43) Pub. Date: Dec. 3, 2009

(54) Behavioral Trust Rating Filtering System

(75) Inventors: John Stannard Davis, III, Corte Madera, CA (US); Eric Moe, Mill Valley, CA (US)

Correspondence Address: STEFAN KIRCHANSKI, VENABLE LLP 2049 CENTURY PARK EAST, 21ST FLOOR, LOS ANGELES, CA, 90067, US

(73) Assignee: John Stannard DAVIS, III, Corte Madera, CA (US)

(21) Appl. No.: 12/281,735

(22) PCT Filed: Mar. 3, 2007
(86) PCT No.: PCT/US2007/063246

§ 371 Date: Dec. 29, 2008

Related U.S. Application Data
(60) Provisional application No. 60/779,082, filed on Mar. 4, 2006.

(51) Int. Cl. G06Q 10/00

(52) U.S. Cl. 705/10

(57) ABSTRACT

An improved rating system allows users to give anonymous ratings of any item such as devices, compositions and services including personal services (i.e., individuals). The system is based on degrees of behavioral similarity between raters. The highest degree of behavioral similarity is established between raters who have rated the same item identically or similarly. The system allows a user to view ratings or anonymous raters who have a high degree of behavioral similarity to the user. The system allows users to control the various ‘degrees’ or levels of behavioral linkage to gather meaningful data in a way that greatly extends the potential usefulness and applicability of the rating filtering system while preserving the anonymity of raters and their individual ratings.

### CROSS-REFERENCE TO PRIOR APPLICATIONS

The present application is a National Phase continuation of and claims priority from PCT/US2007/063246, filed on Mar. 3, 2007 designating the United States, which in turn was based on and claimed priority from U.S. Provisional Patent Application No. 60/779,082 filed Mar. 4, 2006 both of which applications are incorporated herein by reference.

### U.S. GOVERNMENT SUPPORT

NA

### AREA OF THE ART

The present invention concerns systems for rating people, objects or services and more particularly discloses an anonymous, contextual, relational, rating system which allows end-user (consumer) controlled filtering of ratings based upon raters' “rating behavior.”

### SUMMARY OF THE INVENTION

The present invention results from our perceived need for better ratings systems than those which are currently available particularly in online environments. We believe that our new system addresses widely perceived problems with online commerce and recommendation systems in a way that is unique and valuable to ratings consumers. This inventive system helps prevent or avoid fraud and rating peer pressure (whereby non-anonymous rating parties feel compelled to give inaccurate ratings to others for ulterior motives—i.e., mutual benefit or retaliation). The present system allows raters to make accurate ratings without concern that their identity can be associated with their ratings. Further, this system allows users to leverage raters' behavior to filter information, much as they might in real life—finding personalized, private recommendations and ratings that might be more accurate, meaningful, and effective. The inventive system mimics aspects of people's real-life decision making processes, yet it affords greater speed, power, and scope because it leverages modern information technology.

This inventive system, as demonstrated by the features explained below, is different in several important ways from known current efforts to filter ratings. The method of the invention is practical and fairly simple in concept for users to understand. The invention provides complete privacy to end-users and allows users to understand and control filters applied to ratings based upon rater behavior criteria. In addition, it allows users to control the various ‘degrees’ or levels of behavioral linkage to gather meaningful data in a way that greatly extends the potential usefulness and applicability of the rating filtering system while preserving the anonymity of raters and their individual ratings.

We believe that the efforts of the prior art, including collaborative filtering and trust network filtering, fall short in several ways that our system addresses—primarily by giving full control and anonymity to end-users and by extending the usefulness of such methods by leveraging the concept of ‘links of behavioral similarity.’ We believe that the end-user will remain the best determiner of useful and personally relevant information for some time to come and that technology best affords more powerful techniques and tools for gathering information that users want for making their decisions. Our system is a practical and helpful system that places control in the hands of the end-user with the belief that end-users will increasingly demand and be best served by such control. We believe that our invention will enhance and improve the value and safety of online e-commerce systems.

### BRIEF DESCRIPTION OF THE DRAWINGS

FIG. 1 is a diagram illustrating the concept of degrees of separation of behavioral similarity;

FIG. 2 is diagram illustrating multiple paths of Common Rating Behavior;

FIG. 3 shows an illustration of a “threshold number of ratings;”

FIG. 4 illustrates a sample rating form which a user might use to rate a ‘babysitter’ on several criteria;

FIG. 5 illustrates a sample form which could be used to rate a restaurant on several different criteria;

FIG. 6 shows one embodiment of a form which allows a ratings consumer to select or specify babysitter ratings filter criteria;

FIG. 7 shows several possible views of filtered rating results;

FIG. 8 outlines the steps a user would go through to use one embodiment of the inventive system;

FIG. 9 illustrates typical components used to implement one embodiment of the inventive system; and

FIG. 10 illustrates components used in an alternate embodiment.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide an improved behavior filtered rating system.

Note that in the drawings the letter “U” stands for a system user who is the person using the system to obtain a filtered rating. The letter “R” stands for a rater—a person providing a rating. the user is a specialized case of rater. The letter “S” stands for a seller, that is, the person or item being rated. Large doubled ended arrows drawn with solid lines indicate the degree of separation of common rating behavior. Single ended large arrows drawn in dotted line indicate the act of rating and show an “R” values which is the rating. A solid single line arrow represents the CRB path that is the path of Common Rating Behavior.

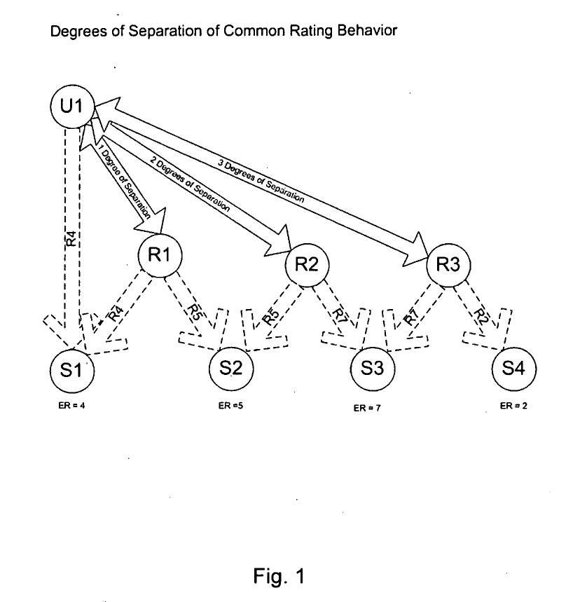

The diagram shown in FIG. 1 explains the concept of degrees of separation of behavioral similarity. A user U1 and a rater R1 have both given the same rating (R4) a seller S1 so they share common rating behavior directly and thus share ‘1 degree’ of behavioral similarity. The user U1 and a second rater R2 do not directly share similar rating behavior (R4 versus R5), but the second rater R2 does share common rating behavior with the first rater R1—thus the rater R2 shares ‘1 degree’ of behavioral similarity with the rater R1 and ‘2 degrees’ of behavioral similarity with the user U1. Similarly, a third rater R3 shares ‘1 degree’ of behavioral similarity with the rater R2, ‘2 degrees’ of behavioral similarity with the rater R1, and ‘3 degrees’ of behavioral similarity with the user U1. If ratings for these behavioral similarities are contextually similar and/or the user deems them relevant and trustworthy the user can decide to use filters or weighting schemes for ratings based upon these relationships of trusted behavior. Note that effective ratings (ER) represent the rating for the shortest path of common rating behavior. Thus, the shortest path between the user and S1 is the 1 degree of R4 path so the ER for S1 is 4. Similarly the shortest path to S2 is R5 (ER=5) and to S3 the shortest path is R7 (ER=7).

Key Features of the Invention

Anonymity: raters remain anonymous, not just for the sake of rater privacy, but to promote/facilitate rating candidness and accuracy. Ratings are typically not associated with a particular user in a way that allows the rater to be identified. These anonymous ratings are typically non-refutable in this system and are not controllable by the persons or items being rated.

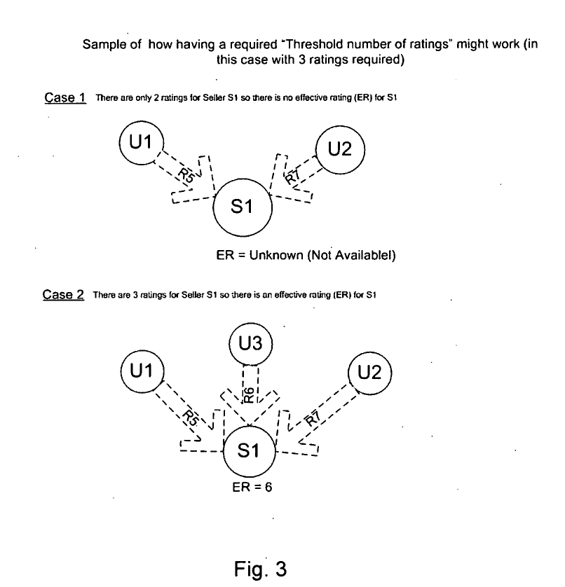

Preservation of Anonymity: Preservation of user anonymity is of paramount importance to this system and requires non-trivial protective measures. These measures include having threshold numbers of anonymous ratings before showing a composite rating. This is illustrated in FIG. 3. which shows an example of how a ‘threshold number of ratings’ can be required, in some embodiments of this inventive system, before showing aggregated ratings for a given item (in this case a seller). This is only one of many possible ways to try to preserve rater anonymity that the inventive system can accommodate. In Case 1, only two users (U1 and U2) have rated a seller (S1) so no aggregate rating is shown. In Case 2, three users (U1, U2, and U3) have rated a seller (S2) so an aggregate rating can be displayed.

Context of ratings: this system facilitates discovery, creation, and use of contextually meaningful ratings. Context can be of any type—e.g., kind of transaction completed (if any), size of transaction, type of item or service exchanged/sold, geography, season/date, etc. Meaningful context may vary with precise implementation and from transaction to transaction.

Ratings can be filtered contextually where the user sets explicit filters, or where the context is built to match the end-user's environment. Online auction systems with user ratings often provide the classic example of how fraud and problems can arise because contextual ratings filters are lacking. For example, a rating for a seller who sold and received high ratings for selling lots of one dollar tools should not necessarily apply when the seller tries to sell a million dollar home.

Behavioral Trust Rating Filters: ratings are filtered and/or weighted according to rating behavior of raters as known by the system. An end-user (ratings consumer) can filter ratings based upon the ratings behavior of raters in relation to the end-user's own rating behavior. The ratings may be filtered based on similarity or dissimilarity of behavior. An end-user may filter for ratings from raters who have rated contextually relevant items similarly (or dissimilarly) to the end-user's own ratings for such items. For example: a consumer might wish to see ratings for plumbers from people who've rated a certain plumber, P1, highly (because the consumer thinks that the plumber, P1, is good and has rated the plumber highly), and the consumer might wish to not see ratings from people who've rated another plumber, P2, highly (because the consumer thinks that this other plumber, P2, is poor and has given the plumber a low rating). These factors can be combined so the most effective filter might be raters that have rated P1 highly and rated P2 poorly.

This inventive system allows an end user to filter ratings not just based on direct similarity of raters' rating behavior to some end-user criteria, but also based upon a social network where connections between people are built based on behavioral similarity. For example, a consumer (C) who has rated a babysitter (B1) may wish to see ratings for another babysitter (B3) by raters who have rated B1 similarly to how C rated B1. In cases where there are no such raters who have rated B1 similarly to C and have also rated B3. C may then be interested in ratings from raters who have rated B3 and do not have similar ratings in common with C for B1, yet they share similar ratings for another babysitter (B2) with raters with whom C does share similar ratings for B1. In other words, if there are no ratings from raters with ‘1 degree of rating similarity’ to C, there may be ratings from raters with ‘2 degrees of rating similarity’ to C that are of interest to C. Similarly, the ‘degrees of rating/behavioral similarity’ may extend further with continued possible value to C.

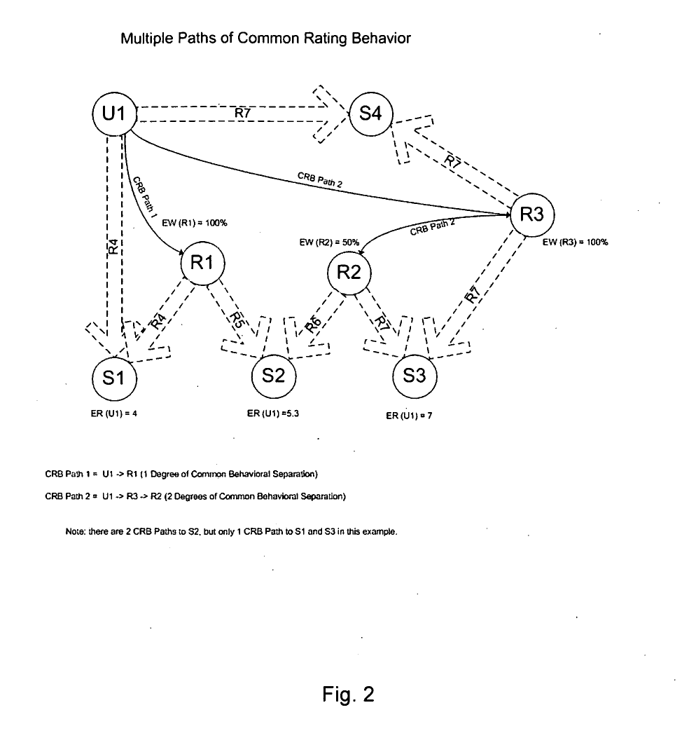

FIG. 2 shows an example of how a ‘2 degree’ path might look for a similar situation—particularly if there were no ‘1 degree’ path of common rating behavior to an item for which the user would like to see ratings (in this case a seller) a ‘2 degree path’ might be considered more useful than no path. When multiple paths lead to the same item of interest, there are any number of rating filtering and weighting methods that might help the user resolve these multiple paths into more personally relevant ratings. This ‘chain of links of behavioral similarity’ can be extended to any degree, thus greatly increasing the value and usefulness of ‘behaviorally similar ratings filters’. If a rater has given a certain item a rating that is similar to the user's rating for that item, then this rater would be ‘1 degree’ of separation of behavioral similarity from the user. If a rater shares no rating behavior directly with the user, but shares similar rating behavior with another rater who does directly share behavioral similarity with the user-then the rater is ‘2 degrees’ of separation of behavioral separation from the user, and so on.

FIG. 2 illustrates the first two degrees of this type of relationship. The drawing shows how there might be multiple paths of Common Rating Behavior (CRB) between a user U1 and an item (in this case a seller S2). The user U1 and a rater R1 share ‘1 degree’ of behavioral similarity because they have both given the same rating (R4) to the seller S1. The user U1 and a second rater R2 share ‘2 degrees’ of behavioral similarity because the user U1 has a ‘1 degree’ relationship with rater R3 (because of S4) and rater R3 has a ‘1 degree’ relationship with rater R2. Because the raters R1 and R2 have both rated the second seller S2, there are two ratings for the seller S2 which might be used in a filter of the user's choosing. In this example, the user has chosen to weight (Effective Weight, EW) ratings with ‘1 degree’ of behavioral similarity more strongly (100%) than ratings with ‘2 degrees’ of behavioral similarity (50%). The filtering and weighting scheme results in an ‘effective rating’ (ER) of 5.3 out of a possible 10 for the seller (S2). That is, the ER is equal to the sum of ratings R multiplied by EW divided by the sum of the Effective Weights. (ER=(SUM (EW*R))/(SUM (EW))). There are many other degrees, paths, and filtering algorithms possible with the inventive system.

End-User Controllability Rating consumers control which rating filters or weighting schemes are applied to ratings or items they are viewing. Filtering criteria are rating behaviors of raters, individually or in any combination. A user might be presented with one or more optional filtering criteria that can manually be selected or the user can be allowed to create and store customized filtering templates. Once created, these templates could be used in an automated fashion on behalf of the user. This allows users to create and conveniently use filters which are valuable to them. In addition, once such a filter has been created, a user can share the filter with other users.

In addition, users can control the ‘degrees of separation’ of similar rater rating behavior for their chosen filters in a manner which preserves rater anonymity. An end-user can also choose the filtering algorithm or method which weighs ratings based upon the end-user's rating behavior filtering criteria. Thus, the ratings are customized for the end-user and two end-users are likely to see different ratings for the same item, service or person being rated. This makes it even less likely that the anonymity of a given rater can be compromised.

According to the inventive system ratings can be for goods or services, people or businesses, or any, even multiple, aspects of these. Ratings can be used in many ways from looking up ratings for a seller or potential buyer on Ebay, to searching for items rated highly within a certain context (e.g., “show me the best plumbers on a plumber directory site as rated by people who've rated a certain plumber a certain way”). Ratings can also be applied to leisure activities, or entertainment, such as movies, destinations, exercise programs, recipes, artists, groups, associations, clubs, etc. The inventive system can even be used for rating web sites—for example, in either a search engine or a bookmark sharing application. Ratings can also be used proactively as a search key to “discover” new interests or items, such as finding a new recording artist, band, or film based on ratings from users with certain defined characteristics. In the past if one were searching, for example, for a particular type of book that might be of interest, one could use keywords or phrases hoping to discover something. By keying in on ratings made by persons sharing particular rating behavior, one can uncover interesting books that would hitherto be missed entirely. Ratings can also be used programmatically, such as in an anti-spam program or proxy server where ratings targets may be filtered, black-listed, white-listed, weighted or prioritized based on their rating value. Ratings can be displayed in many ways textually or graphically, and they can even be presented in a non-visual manner such as over a voice communications system.

The inventive system can be used separately or in conjunction with other systems. It can be used within a single online population or service or across multiple online populations or services. It can be integral to or separate from the population or service that it serves. The inventive rating system is not limited to the Internet but can be in any form online or offline, across any medium or combination of media, and it can even incorporate manual or non-automated systems or methods.

The system may filter ratings entirely ‘on demand’ or it may pre-calculate and store ratings or portions thereof for use when filtered ratings are demanded. That is, it may be a ‘real-time’ or a ‘cached’ rating filtering system or a combination of both. The system may also employ conjoint analysis in the pre-calculated ratings. The inventive system encompasses ratings of any form (explicit or implicit, behavioral or associative, etc.), and the ratings can be used for any purpose including automated as well as manual functions.

Filters used with the system need not be absolute, rather they can control the weighting of ratings as well. This system can accommodate any weighting scheme such as weighting ratings according to the difference between the rating behavior of the raters and the ratings consumer (e.g., exact matches weigh more than just close matches), the number of common rating behaviors between the rater and consumer (e.g. 3 matches weighs more than 1 match), or the number of degrees of behavioral separation (e.g. 1 degree of behavioral separation causes stronger rating than 3 degrees of behavioral separation) as shown in FIG. 2.

Filters can be applied singly or in any combination and may be weighted in a combined fashion. For example, a user might wish to weigh ratings from raters who share two similar ratings with the user more strongly than ratings from raters who only share one similar rating with the user. FIG. 2 shows that ratings may also be weighted according to ‘degrees of separation’ of the raters' behavior from the consumer's rating behavior.

The behavioral information concerning raters might be entered by the raters directly, or it might be gathered from other, possibly multiple, sources through automated, semi-automated, and/or manual means. Rater's behavioral information (along with rater identity and possibly other personal rater information) might be validated in one or more ways to improve accuracy. Validation methods could include semantic web methods of using automated cross reference information, authentication by a third party or association, or any other type of manual, automated, or semi-automated method. A third party system for validating rater's behavior could also be used.

For purposes of clarity, there are many potential complexities of this system that are not described or even mentioned in this patent application. This invention encompasses the key concepts and methods described above and all the methods and solutions for implementing such a system and addressing many of its subtle complexities. Those of skill in the art will readily understand how to deal with such complexities on the basis of the explanations provided herein.

System Components

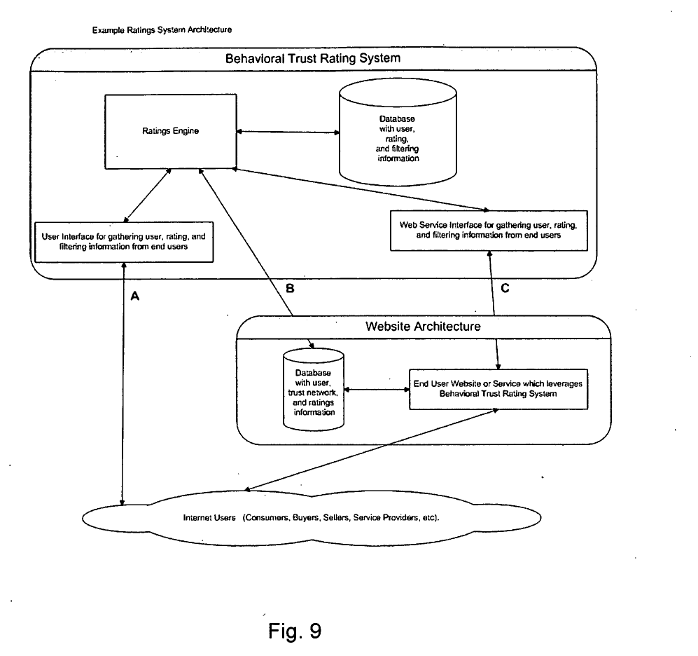

The system components are described using a sample embodiment with an online e-commerce system where buyers and sellers can rate each other as shown in FIG. 9. First, an e-commerce website gathers and stores users' ratings, ratings context, and contextual behavioral filtering information. The system provides a Mechanism/Method for allowing users to understand and control the calculation and presentation of ratings based upon their behavioral trust filters while preserving the anonymity of raters.

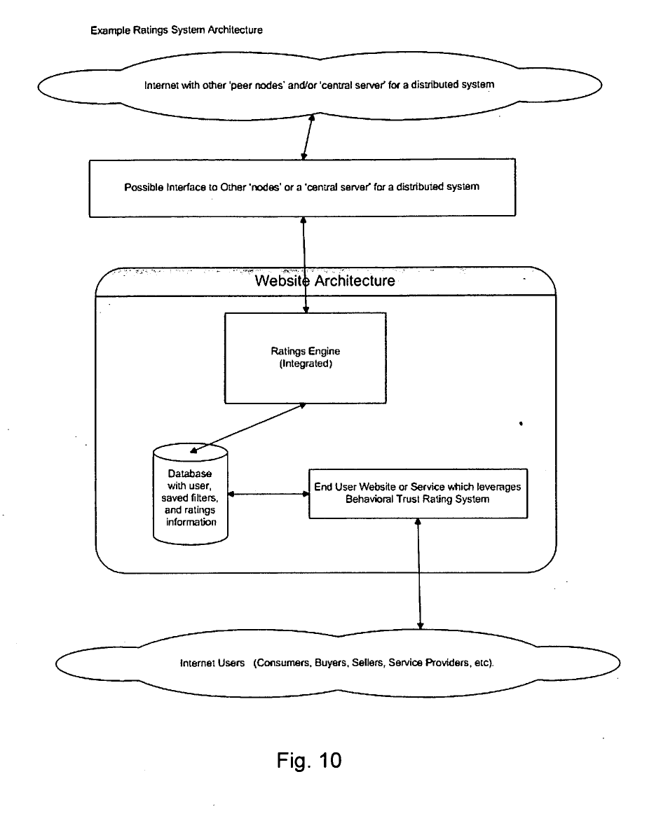

Mechanism/Method: The interaction of components of a Ratings Engine for calculating/filtering users' ratings based upon a viewer's contextual trust network association with raters can be seen in FIGS. 9 and 10. Essentially, an e-commerce website with a population of using buyers and sellers collects and stores users' anonymous ratings of each other (typically only those with whom they've transacted) and transactional information necessary to provide a rating any needed context (e.g., type of transaction, date of transaction, type of item sold, cost of item, type of payment, etc.). The system accommodates the gathering and storage of users' behavioral filtering criteria. FIG. 9 is an illustration of typical components in one implementation of the inventive system from an application component perspective. Here user input can be gathered directly from the “Behavioral Trust Ratings System” (Interface A—a possible interface to the inventive system), from an integrated client database (Interface B) or through a third party website via an API (application program interface), web service, or integrated functionality (Interface C). Ratings information which the Ratings Engine calculates using users' ratings and behavioral trust filtering information can be displayed to the user via Interface A or through a client website using Interface B or Interface C (or any combination of these types of interfaces). The Ratings Engine would typically be a separate system from the e-commerce site, though it may, in some embodiments, be an integral part of a ‘client’ website (or other type of client) as well (e.g., see FIG. 10).

FIG. 10 is an Illustration of typical components in another embodiment of the system from an application component perspective. Here the Behavioral Trust Ratings System obtains required user, filtering, and ratings data directly from a database that it shares with a website or web service that leverages the Behavioral Trust Ratings System. This could comprise one independent ‘node’ of a larger ‘distributed network’ of independent systems which implement the inventive system. As will be apparent to one of skill in the art, there are many additional component architectures that are compatible with the inventive system.

With the illustrated system, users can select or create a ratings filter or view based upon similarity of raters' rating behavior to the user's own. The ‘Ratings Engine’ then calculates behavioral trust-based ratings values according to the filter selected by the user in a way that preserves rater anonymity. These ratings, which may be calculated in real-time or may be partially or wholly pre-calculated, are passed back to the user for viewing in a manner that preserves rater anonymity. The user interface for gathering behavioral trust filtering data, and displaying ratings information based upon the user's behavioral trust filtering information may be integral to or separate from the e-commerce website application. Thus, the ratings system can be comprised of a separate system, software application, and/or hardware appliance which handles the entire information gathering and ratings filtering, or it can be comprised wholly or partially of pieces of software and hardware integral to the e-commerce (or other) system or online population which it serves.

FIGS. 9 and 10 illustrate how these components interact. 1) An ecommerce website with a population of buyers and sellers collects and stores users' anonymous ratings of each other (typically only those with whom they've transacted) and transactional information necessary to give a rating any needed context (e.g., type of transaction, date of transaction, type of item sold, cost of item, type of payment, etc.). 2) Users who have their own behavioral information in the system can select a ratings filter or view based upon various aspects of their behavior (e.g. Degrees of Separation of Behavior and/or Effective Trust Level of these degrees or types of common behavior). 3) The ‘Ratings Engine’ calculates ratings values according to the filter selected by the user in a way that preserves rater anonymity. These ratings, which may be calculated in real-time or may be partially or wholly pre-calculated, are passed back to the user for viewing in a manner that preserves rater anonymity.

The user interface for gathering behavioral data, and displaying ratings information based upon the user's behavioral ratings filter may be integral to or separate from the e-commerce website application. Thus, the ratings system could be comprised of a separate system, software application, and/or hardware appliance which handles the entire behavioral information gathering and ratings filtering, or it could be comprised wholly or partially of pieces of software and hardware integral to the e-commerce (or other) system or online population which it serves.

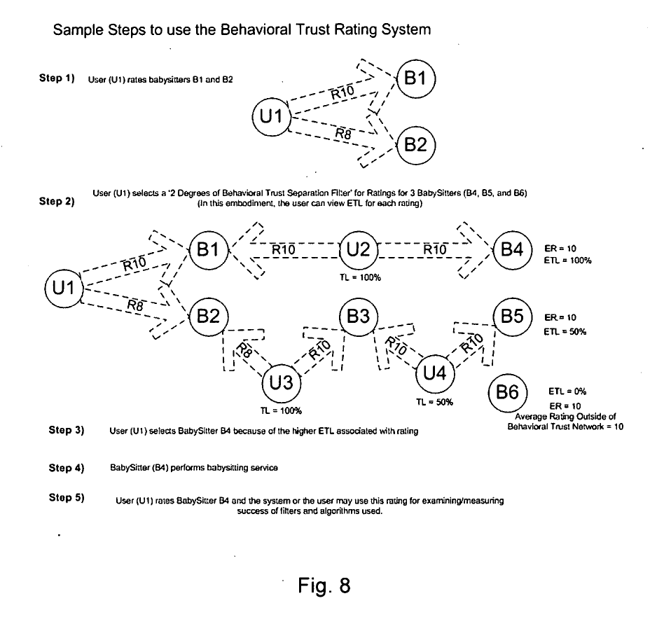

FIG. 8 illustrates how a user would use the system according to one embodiment. Here “S” is replaced by “B” for baby sitter as the item being rated. This particular implementation relies upon the user being able to see the Effective Trust Level (ETL) for each Effective Rating (ER) in order to make the probable best choice (the one with the highest effective trust level (ETL)). Note that Trust Levels are essentially the same as Effective Weight where ‘1 degree’ relationships give an EW or TL of 100% and ‘2 degree’ relationships give an EW or TL of 50%. Other implementations can use an algorithm to change the ER values based upon the ETL or other factors. Of course, the end-user can see and control the filters used.

In actual practice the user follows these steps. 1) In a first step the user U1 rates item/service/person (here a baby sitter) B1. 2) In the next step the user U1 selects a ‘2 degree of behavioral trust’ ratings filter for ratings for baby sitters B4, B5, and B6. 3) In the third step the user U1 views the filtered ratings which are calculated by the Ratings Engine which calculates and applies the specified behavioral filter; note that the user can view the Effective Trust Levels. On the basis of the ETLs B4 is selected because that baby sitter has the highest rating coupled with the highest ETL. 4) In the next step the user buys, rents, uses, or transacts (partially or wholly) with item/service/person B4. 5) In the final step the user rates the item/service/person B4—based upon one or more criteria. The user's rating may be used as feedback by the Ratings Engine to examine and adjust (or suggest adjustment to) the user's filtering settings or to adjust or create filtering algorithms to increase the usefulness of the system. Note that the ETL for a trust path is all of the TLs in the path multiplied together. The ETL for each user is the average of all the ETLs of the paths leading to a user. The Effective Rating (ER)=SUM (ETL*R)/SUM (ETL).

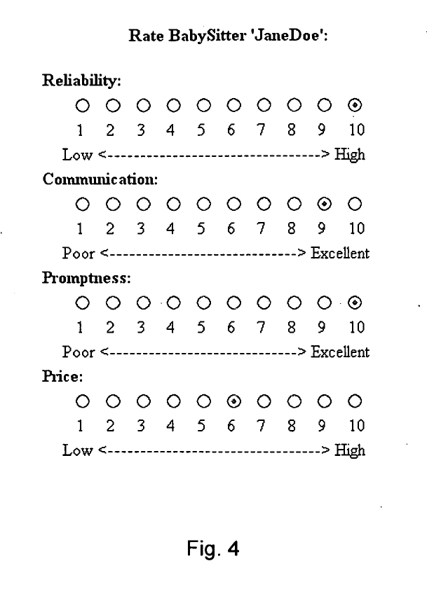

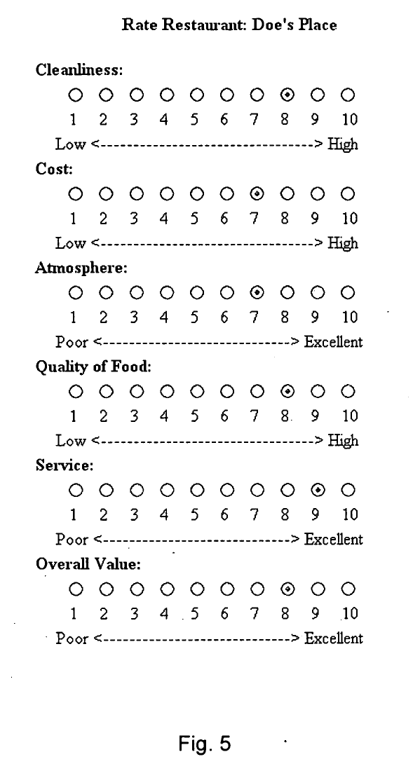

FIGS. 4 and 5 illustrate forms useful in the above sequence for inputting ratings.

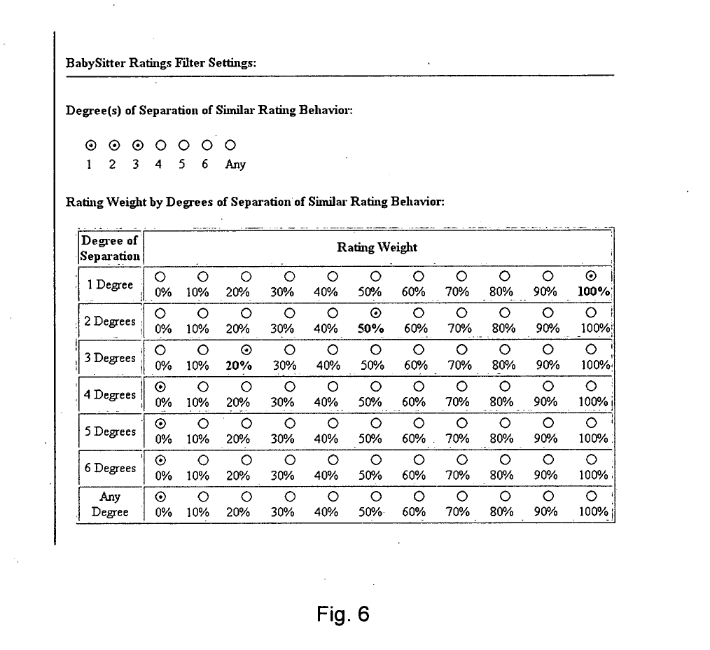

FIG. 6 shows details of a form that would enable users to apply different ratings filters to a babysitter rating. In the illustrated example a user can select how many ‘degrees of behavioral similarity’ should be used in the filter as well as the weight applied to each ‘degree of behavioral similarity’ when aggregating more than one score for a particular babysitter.

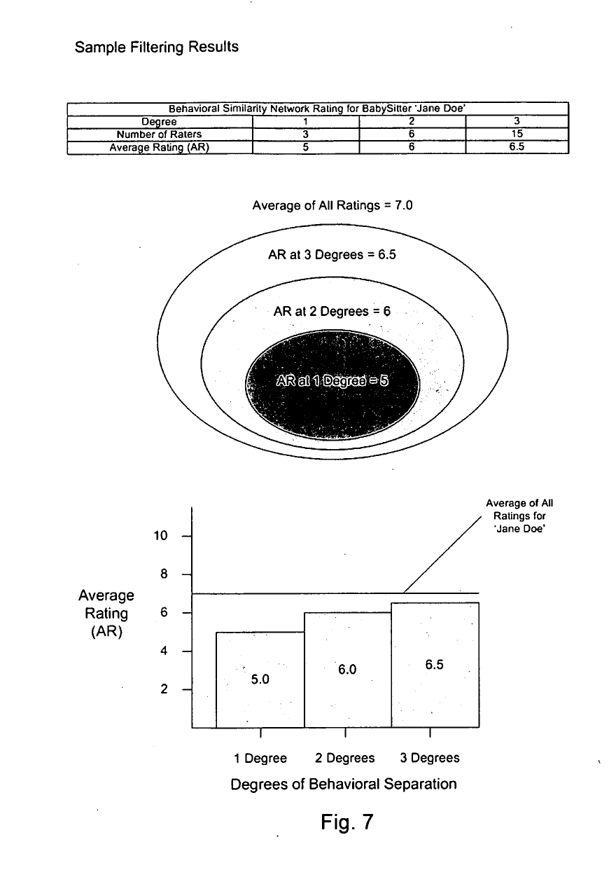

FIG. 7 shows several possible views of filtered rating results by means of a table with degrees of behavioral similarity, number of raters, and average rating for each degree of behavioral similarity; and two visual displays of showing Average Ratings for each of 3 degrees of behavioral similarity of filtered ratings. This type of display is a powerful demonstration of the importance of the degree of behavioral separation. In this example the Average Rating overall for “Jane Doe” is higher than either the 1 degree, 2 degree or 3 degree behavioral separation ratings. This indicates that the more closely related raters are more critical of “Jane Doe.” This type of useful information filtering can be controlled by allowing system users to determine the exact rating filter to be applied. Alternative methods for displaying these and related rating results can be readily accommodated by the inventive system.

Configurations

The inventive system is extremely flexible. It is likely that considerable actual use will be necessary before an optimum configuration is discerned. At this time it appears likely that a preferred embodiment will involve the creation of a separate system which gathers users' personal information and allow filtering of ratings based upon this data. This will allow the system to more easily scale and grow on its own and will allow the system to serve more than one ‘client’ service population (e.g., multiple e-commerce sites) at the same time, possibly allowing users to have a much more broadly useful ratings filtering tool that they can use and leverage across different services and products. Such a system would allow users to enter their personal information in one location but allow their ratings to be filtered in more than one online environment using their profile information. Context of ratings remain an important aspect of all implementations of this system.

Certain embodiments of this system might use a distributed, possibly peer-to-peer (or other), architecture or a combination of system architectures. Ratings may have persistence (e.g., be fixed in time so a single user can provide several ratings for an item) or non-persistent (e.g., where a single user can provide only a single rating for a given item but can adjust that rating at any time) or have a combination of different (possibly other) types of persistence.

In some embodiments users might allow their rating filters to be leveraged automatically or semi-automatically on their behalf in ways that they can control and understand and that are in line with the key elements of this invention. For example, a user might create or select behavioral filters for the system to use automatically for filtering ratings on their behalf. These embodiments would allow users to leverage preset filters or ‘filtering templates’ for quick re-use—possibly in an automated fashion. In another embodiment, the system automatically calculates and displays behavioral filters for all users based upon the user's rating behavior. All embodiments would preserve rater anonymity, and users could choose to ignore or turn off or, in some embodiments, adjust the automated filtering mechanism. Various algorithms and methods for managing context could be used. These automated embodiments would give users custom ratings that are possibly more accurate the more users use the system (since behavioral similarity filters would tend to be more valuable with greater sampling).

There are many possible filters that can be used in this system. In fact, by allowing people to build their own custom filters in some embodiments (and by inferentially studying the data gathered by consumer filters, filter usage, and ratings) this system can provide continual opportunities to create and improve filters (and formulae) that can be accommodated by the system. It is our expectation that such a system would continually grow and improve.

One embodiment of this system might allow third party filters or algorithms to be ‘plugged in’ to the system through an API. Another, distributed model, might leverage different algorithms, filters and methods at different ‘nodes’ in the system.

An alternate embodiment of this system allows users to reference other than their own behavior as the filtering behavior criteria. For example, a consumer may wish to see ratings for an item I1 from raters who have rated another item I2 a certain way. This allows users to leverage valuable rater behavior without the requirement that the users actually have known behavior within the system. While this can greatly increase the usefulness and applicability of such a system, the challenge of preserving rater anonymity can increase with this type of embodiment.

Filtered behaviors need not be limited to rating behavior. For example, a user may wish to see ratings for construction estimating software from raters who work with construction projects of a certain size.

Advantages of the Inventive System

The inventive system puts control in the hands of the end-users and provides information that is similar to the information people use to make important decisions. It gives end-users the power of collaborative filtering that advertisers often leverage to sell items or services to their customers (e.g., Amazon.com). One difference between the prior art and the present invention is that this information and information control is at the hands of the end-user and is leveraged for the benefit of the end-user's decision-making process. A major difference between this invention and the prior art is the creation and use of the concept of ‘degrees of separation’ of behavior between users and raters. Leverage of this concept extends the usefulness and power of this inventive system far beyond typical ‘collaborative filtering’ efforts. This system allows end-users to leverage modern technology to gain potentially powerful and meaningful information that can help them make better decisions when choosing amongst goods, services, people, or businesses. An additional advantage is that this system will be easy for people to understand and trust—it allows them to avoid concerns common to other systems which don't clearly reveal to the user how ratings or rankings are constructed and insures the integrity of the results (for example, Google's ranking of search results is problematic at best in that rankings can be purchased or manipulated through various means); or which have issues of possibly inaccurate ratings because of social/business pressures (Ebay and other non-anonymous ratings systems); or which may be more likely to be vulnerable to fraud (Ebay, etc.).

The Internet is too large, and too dangerous. Parents can no longer let their children “surf” the web without providing useful context and limits, and screening programs no longer work effectively. This applies to shopping, searching, researching, and even “chatting.” The Internet needs personally relevant context to mitigate risks, offer good choices and information, and be optimally useful for individuals—we believe that our invention is one method for providing such usefulness. We also believe that as people become more sophisticated users of online services, they will increasingly demand the type of ratings and information control provided by our invention.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

What is claimed is:

1. A method for implementing a rating system for use by a plurality of raters comprising the steps of:
accumulating the rating scores resulting from the plurality of raters rating a plurality of items;
establishing degrees of behavioral separation between each of the raters based on raters having given the same or similar rating score to the same item; and
producing a filtered rating score of a particular item wherein the degree of behavioral separation between the raters and a particular rater is used in conjunction with the rating scores for the particular item to obtain the filtered rating score relevant to the particular rater.

2. The method according to claim 1, wherein the step of producing a filtered rating further comprises filtering on the basis of how the raters rated an item other than the particular item.

3. The method according to claim 1 further comprising a step of protecting the anonymity of the raters.

4. The method according to claim 1, wherein the filtered rating score is based on weight selections made by a particular system user.

5. The method according to claim 4, wherein the filtered rating score is produced according to the weight selections and according to the degree of behavioral separation between the particular rater and the other raters providing the rating scores.

6. The method according to claim 1, wherein the filtered rating score is produced according to an effective weight for each rater where the effective weight is calculated by dividing 100% by the degree of behavioral separation.

7. The method according to claim 6 further comprising the step of calculating an effective rating for each item where the effective rating equals the sum of all the effective weights for each rater multiplied by the rating score of that rater divided by the sum or all the effective weights.

8. A method for implementing and using a rating system comprising the steps of:
accumulating the rating scores resulting from a plurality of raters rating a plurality of items;
allowing a first rater to rate at least two items from the plurality of items by providing rating scores for each item;
establishing degrees of behavioral separation between each of the raters and the first rater based on raters having given a same or similar rating score to the same items rated by the first rater;
producing filtered rating scores wherein the rating score of each item is filtered according to a behavioral trust separation filter based on the established degrees of behavioral separation, whereby the first rater selects one of the items based on the filtered scores.

9. The method according to claim 8, wherein the step of producing a filtered rating further comprises filtering on the basis of how the raters rated an item other than the particular item.

10. The method according to claim 8 further comprising a step of protecting the anonymity of the raters.

11. The method according to claim 8 further comprising the step of selecting weighting levels to be applied to the rating scores from each different degree of behavioral separation.

12. The method according to claim 11, wherein the first rater selects the weighting levels.

13. The method according to claim 8 further comprising the step of the first rater rating the selected item after evaluating it and using this rating as a measure of success of the system.

14. The method according to claim 8, wherein an effective trust level and a rating score is produced for each item and wherein the first rater selects the item having both the highest rating score and the highest effective trust level.

15. The method according to claim 14, wherein each rater has a trust level related to the degree of behavioral similarity with the first rater and wherein the effective trust level for a path is computed by multiplying the trust levels along the path.

16. A method for implementing a rating system for use by a plurality of raters comprising the steps of:
accumulating the rating scores resulting from the plurality of raters rating a plurality of items;
establishing degrees of behavioral separation between each of the raters based on raters having given a same or similar rating score to the same item;
producing a filtered rating score of a particular item wherein rating scores are weighted according to the selections and according to the degree of behavioral separation between the particular rater and the other raters providing the rating scores; and
protecting the anonymity of the raters.

17. The method according to claim 16, wherein the step of producing a filtered rating further comprises filtering on the basis of how the raters rated an item other than the particular item.

18. The method according to claim 16, wherein the filtered rating is based on weight selections made by a particular rater.

19. The method according to claim 16, wherein the filtered rating score is produced according to an effective weight for each rater where the effective weight is calculated by dividing 100% by the degree of behavioral separation.

20. The method according to claim 19 further comprising a step of calculating an effective rating for each item where the effective rating equals the sum of all the effective weights for each rater multiplied by the rating score of that rater divided by the sum or all the effective weights.
